(19) United States
(12) Patent Application Publication
(10) Pub. No.: US 2024/0190371 A1
(43) Pub. Date: Jun. 13, 2024

(54) DEFORMATION PROFILE

(71) Applicant: BENTELER AUTOMOBILTECHNIK GMBH, Paderborn (DE)

(72) Inventor: Stephan RABL, Ingolstadt (DE)

(21) Appl. No.: 18/533,133

(22) Filed: Dec. 7, 2023

(30) Foreign Application Priority Data
Dec. 8, 2022 (EP) 22212162.6

(51) Int. Cl. B60R 19/34

(52) U.S. Cl. CPC B60R 19/34

(57) ABSTRACT

The disclosure relates to a deformation profile, having two opposite side walls, wherein the side walls are connected by an upper wall and a lower wall and both side walls have at least one bead extending over the entire height H of the respective side wall, wherein an upper corner area is formed between the side walls and the upper wall and a lower corner area is formed between the side walls and the lower wall. The disclosure is characterized in that the upper corner areas and/or the lower corner areas have a concave shape or a chamfer in cross section. The disclosure furthermore comprises a deformation profile arrangement including a deformation profile and an attachment. The deformation profile arrangement is characterized in that the attachment is detachably coupled to the upper wall or the lower wall.

### RELATED APPLICATIONS

The present application claims priority of European Application Number 22212162.6 filed Dec. 8, 2022, the disclosure of which is hereby incorporated by reference herein in its entirety.

### FIELD

The present disclosure relates to a deformation profile, as well as a deformation profile arrangement and a bumper arrangement having such a deformation profile.

### BACKGROUND

Deformation profiles, such as crash boxes based on hollow chamber profiles, are part of bumper arrangements that are arranged on the front or end of a motor vehicle.

Corresponding bumper arrangements have a cross member which extends in the transverse direction of the motor vehicle and have a width which corresponds to the motor vehicle itself or is slightly less. Such a cross member is coupled to the motor vehicle via deformation profiles. In the case of a front bumper arrangement, the deformation profiles are arranged on the front side of the longitudinal member. The cross member and the deformation profiles are separately manufactured components that are joined together. Some variants are screw connections or welded connections.

In case of an impact of the motor vehicle on an object, the deformation profiles are deformed or compressed like an accordion, thus converting kinetic energy into forming work.

In order to control the direction of deformation and the force required for the deformation, holes or slots extending transversely to the direction of travel are able to be provided on the side walls or upper and lower walls when installed on the vehicle. On the other hand, beads are formed into the side walls of the deformation profiles instead. The upper and/or lower wall of the deformation profiles, on the other hand, are designed as a flat surface in order to enable coupling with additional attachments. When the beads are embossed into the side walls of the deformation profiles, forming-related bulges or protrusions arise that protrude beyond the upper and/or lower wall. This makes the coupling of additional attachments to the upper and/or lower wall of the deformation profile more difficult. In addition, the flat surface of the upper and/or lower wall is reduced in size.

The object of the present disclosure is to provide a deformation profile and a bumper arrangement in which, despite the initially mentioned bead arrangement on the side walls, an attachment is able to be coupled to the upper and/or lower wall, via flatly abutting.

### SUMMARY

The above-mentioned object is achieved according to the disclosure with a deformation profile.

The deformation profile according to the disclosure has two opposite side walls, which are connected by an upper wall and a lower wall. The deformation profile is designed as a component having a rectangular or square cross section. The deformation profile is a crash box, such as a multi-chamber crash box. Alternatively, the deformation profile is also able to be a longitudinal member. A longitudinal member is also able to be a component arranged in the front of a motor vehicle, i.e., a front longitudinal member, or a component arranged in the rear of a motor vehicle, i.e., a rear longitudinal member.

The two side walls each have at least one bead extending over the entire height of the respective side wall. The folding process of the deformation profile is able to be controlled and evened out by the beads. An upper corner area is formed between each of the side walls and the upper wall. A lower corner area is formed between each of the side walls and the lower wall. The side walls are connected to the upper wall or the lower wall via the corner areas.

According to the disclosure, the deformation profile is now characterized in that the upper corner areas and/or the lower corner areas have a concave shape or a chamfer in cross section. In the case of deformation profiles with a rectangular cross section, when the beads are embossed into the side walls, bulges arise and are able to protrude beyond the upper and/or lower wall. This results in unevenness of the upper and/or lower wall. Because the upper and/or lower corner areas have a concave shape or a chamfer in cross section, the beads remain within the corner areas and no longer protrude beyond the upper wall or the lower wall. This means the flat surface of the upper and/or lower wall is not affected. The remaining flat surface of the upper wall and/or lower wall is therefore suitable for coupling with an additional attachment.

The deformation profile is a one-piece extruded extrusion profile. The two side walls, the upper wall and the lower wall, and possibly one or more middle walls are extruded in one piece using the same material.

The design of the corner areas according to the disclosure are able to be formed either in the upper area of the deformation profile, in the lower area of the deformation profile, or in both areas. If the two upper corners of the upper corner area have a concave shape or a chamfer in cross section, the surface of the upper wall is correspondingly flat and enlarged and therefore suitable for coupling an additional attachment. In the case of an embodiment according to the disclosure of the lower corner areas, the same applies analogously to the lower wall. Both, the upper corner areas and the lower corner areas have a concave shape or a chamfer in cross section, so that both the upper wall and the lower wall are not affected by protruding beads, and the folding behavior is as symmetrical as possible in the event of an impact result.

In at least one embodiment of the disclosure, a deformation profile has two opposite beads in the side walls, wherein the two mutually opposite beads are arranged in the same length section of the deformation profile. The two beads are diametrically opposed to each other. The deformation profile is designed in a mirror image with respect to the vertical center longitudinal plane. Such a deformation profile is characterized by a symmetrical folding behavior, such as in the event of an impact or shock axially in the longitudinal direction of the deformation profile.

In the case of a chamfer, such as a chamfer angle α is formed between 25° and 65°, or between 40° and 50°. That is, the chamfer extends at an angle of between 40° and 50° in relation to an upper wall or lower wall and the adjacent side wall.

For the upper corner area, the chamfer angle lies between the chamfer and an upper wall plane or horizontal plane. For the lower area, the chamfer angle lies between the chamfer and a lower wall plane or horizontal plane.

Furthermore, the chamfer has a length of between 12 mm and 25 mm in cross section.

The upper wall and/or the lower wall has an outer overall surface. The overall surface includes the flat surface extending in a horizontal plane plane-parallel to the horizontal and the surface portion(s) of the corner area surfaces that are inclined to the horizontal and extend through the corner areas. Within the scope of the disclosure that the proportion of the flat surface to the overall surface of an upper wall and/or a lower wall is 30% to 65%.

The flat surface is configured and intended to secure at least one additional attachment to the deformation profile.

The chamfer width is less than a third, less than a fourth of the crash box width. This contributes to achieving a large flat surface.

In the case of a concave design of the corner areas, the concave shape has a radius between 12 mm and 25 mm. The radius is between 13 mm and 20 mm. In this context, there is enhanced utility if the radius is less than a third, or less than a fourth, of the crash box width. This measure also ensures the largest possible proportion of the flat surface to the outer overall surface of the upper wall and/or the lower wall.

The deformation profile itself has a wall thickness between 0.5 mm and 4 mm, or in between 1 mm and 3 mm.

If only the upper corner areas or only the lower corner areas have chamfers according to the disclosure or a concave shape according to the disclosure, the remaining corner areas of the deformation profile have no chamfer or no concave shape. No chamfer or no concave shape means that these corners have a radius or a chamfer that is at least 20%, 33%, and 50% less in relation to the corner areas according to the disclosure having a concave shape or chamfer. For example, if a corner area according to the disclosure having a concave shape had a radius of 20 mm, the radius of a corner not designed according to the disclosure is less than 10 mm.

The upper wall and/or the lower wall is flat. Coupling with an additional component is significantly simplified by an appropriately flat design. The upper wall and the lower wall are flat not only in the longitudinal section having the bead(s) in the side wall (side wall beads), but over the entire length of the deformation profile, so that a large-area, flat attachment surface results.

The deformation profile is able to be produced by extrusion and is made of a light metal material, e.g., aluminum alloy.

The deformation profile is part of a bumper arrangement of a motor vehicle. In this case, the deformation profile is able to be connected to a flange plate or directly to a cross member by means of screws or a weld seam. In addition, the deformation profile is able to be screwed to the longitudinal member.

The deformation profile arrangement according to the disclosure includes a deformation profile and an additional attachment. The deformation profile arrangement is now characterized by the fact that the attachment is detachably or non-detachably coupled to the upper wall or the lower wall. The deformation profile according to the disclosure has a flat upper wall and/or lower wall due to the design of the corner areas as a concave shape or as a chamfer. The upper wall and/or lower wall therefore have a suitable coupling surface for coupling to an attachment.

Attachments are able to be, for example, load path supports, radiator supports, headlight holders, and similar functional and/or safety attachments.

The arrangement according to the disclosure also includes two attachments, such that one attachment is detachably coupled to the upper wall and one attachment is detachably coupled to the lower wall.

A deformation profile arrangement is, for example, a bumper arrangement for a motor vehicle. The bumper arrangement has a cross member which is supported directly or indirectly on longitudinal members of the motor vehicle via two deformation profiles according to the disclosure on the motor vehicle. The cross member is connected to the vehicle via the deformation profiles, wherein the deformation profiles are designed as a multi-chamber profile and have at least one inner wall. The inner wall extends parallel to the top wall and bottom wall between the two side walls. The inner wall has a deformation directed upward or downward in the form of a hump in a longitudinal section having a bead.

### BRIEF DESCRIPTION OF THE DRAWINGS

Further advantages, features, properties, and aspects of the present disclosure are the subject matter of the following description. Various embodiments are shown in the schematic figures. These simplify the understanding of the disclosure. In the figures:

FIG. 1A shows a perspective of a deformation profile known from the prior art,

FIG. 1B shows a deformation profile known from the prior art in cross section according to section I-I of FIG. 1A,

FIG. 2A shows a perspective of a deformation profile according to the disclosure,

FIG. 2B shows a deformation profile according to the disclosure in cross section according to section II-II of FIG. 2A,

FIG. 2C shows a deformation profile according to the disclosure in cross section according to section III-III of FIG. 2A,

FIG. 3A-FIG. 3C show a deformation profile according to the disclosure in cross section in different embodiment variants, and

FIG. 4 shows a deformation profile arrangement according to the disclosure comprising a deformation profile and an attachment.

### DETAILED DESCRIPTION

In the figures, the same reference numbers are used for same or similar components, even if a repeated description is omitted for reasons of simplicity.

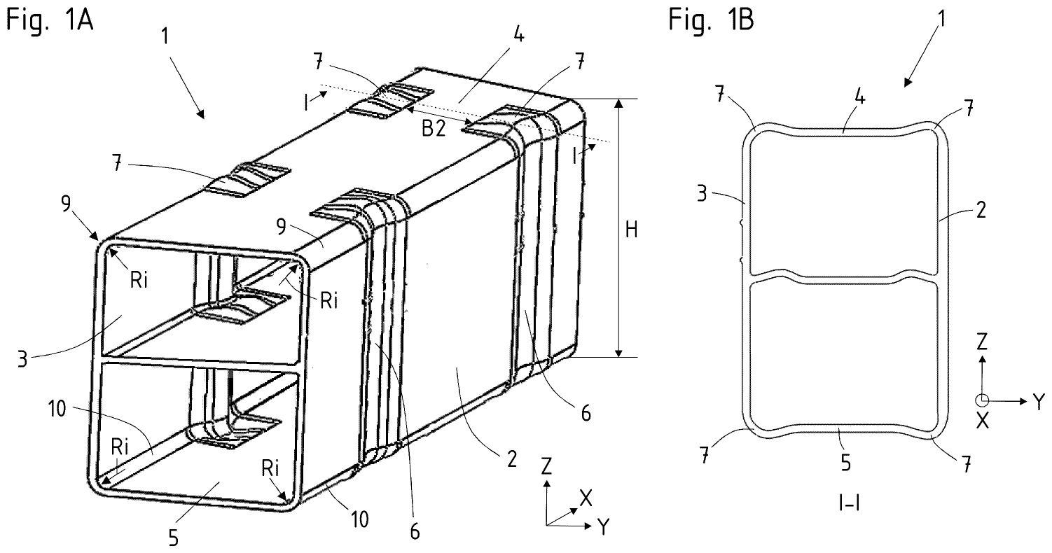

FIG. 1A shows a deformation profile 1 known from the prior art, which is a crash box designed as a two-chamber hollow profile. The deformation profile 1 has two opposite side walls 2, 3, wherein the side walls 2, 3 are connected by an upper wall 4 and a lower wall 5. The deformation profile 1 has a rectangular shape in cross section. The term cross section refers to the cross section in the y-z plane. Both side walls 2, 3 have beads 6 extending over their entire height H. Due to the embossing of the beads 6, they have bulges 7 at the upper and lower ends, which protrude beyond the upper wall 4 and the lower wall 5.

FIG. 1B shows the deformation profile 1 known from the prior art in cross section according to section I-I of FIG. 1A, i.e., the section through the opposite beads 6. The bulges 7 protrude beyond the upper wall 4 and the lower wall 5. Both the upper wall 4 and the lower wall 5 therefore do not have a flat or level surface in the longitudinal section having the beads 6, which makes coupling to an attachment 8 difficult, which is initially not shown in detail here. An upper corner area 9 is formed between the side walls 2, 3 and the upper wall 4 and a lower corner area 10 is formed between the side walls 2, 3 and the lower wall 5. The corner areas are convex and have a radius Ri.

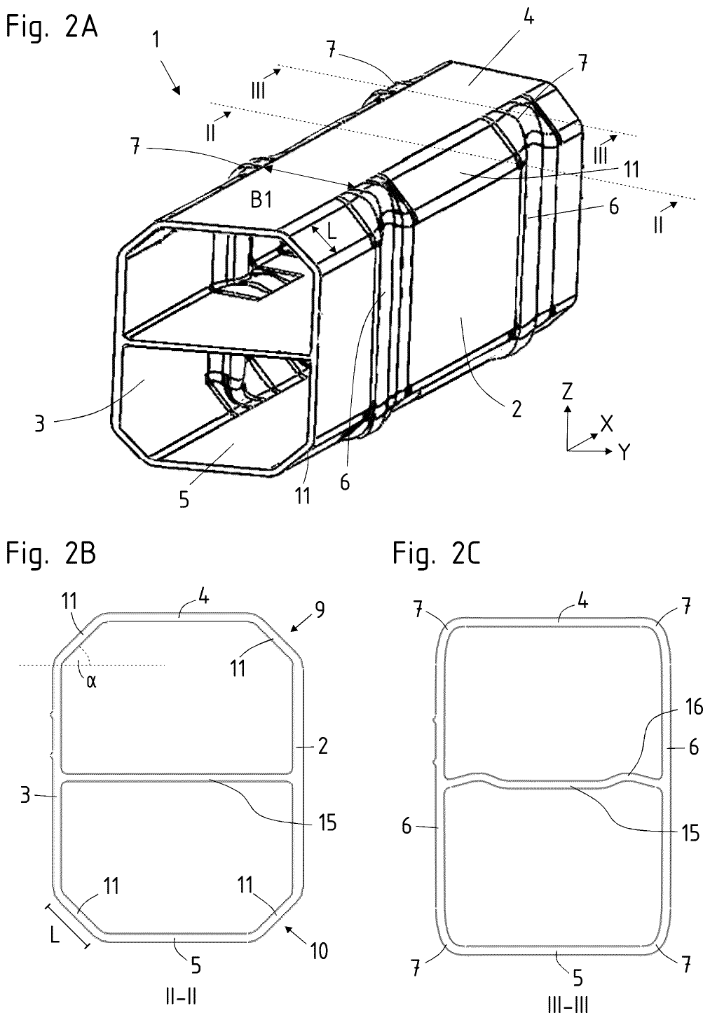

FIG. 2A shows the perspective of a deformation profile 1 according to the disclosure, which is also a crash box designed as a two-chamber hollow profile. In comparison to the deformation profile 1 according to the prior art, shown in FIG. 1A, the upper corner areas 9 and the lower corner areas 10 according to the disclosure have a chamfer 11 in cross section. The bulges 7 created by the embossing of the beads 6 result in the chamfer 11 bulging outward. However, the chamfers 11 ensure that the bulges 7 do not protrude beyond the upper wall 4 and/or the lower wall 5. The coupling with an additional attachment 8 is not obstructed due to the still flat upper wall 4 or lower wall 5. The chamfers 11 also increase the width B1 of the upper wall 4 and/or the lower wall 5 in relation to the width B2 of the upper wall 4 and/or the lower wall 5 of the deformation profile 1 according to the prior art. This results in a larger coupling area for coupling with an additional attachment 8.

FIG. 2B shows the deformation profile 1 according to the disclosure in cross section according to section II-II of FIG. 2A. The bevels 11 have a chamfer angle α of 45°.

The bevels 11 also have a cross-sectional length L between 12 mm and 25 mm.

FIG. 2C shows a cross section of the deformation profile 1 according to section III-III of FIG. 2A. The bulges 7 do not protrude beyond the upper wall 4 or the lower wall 5.

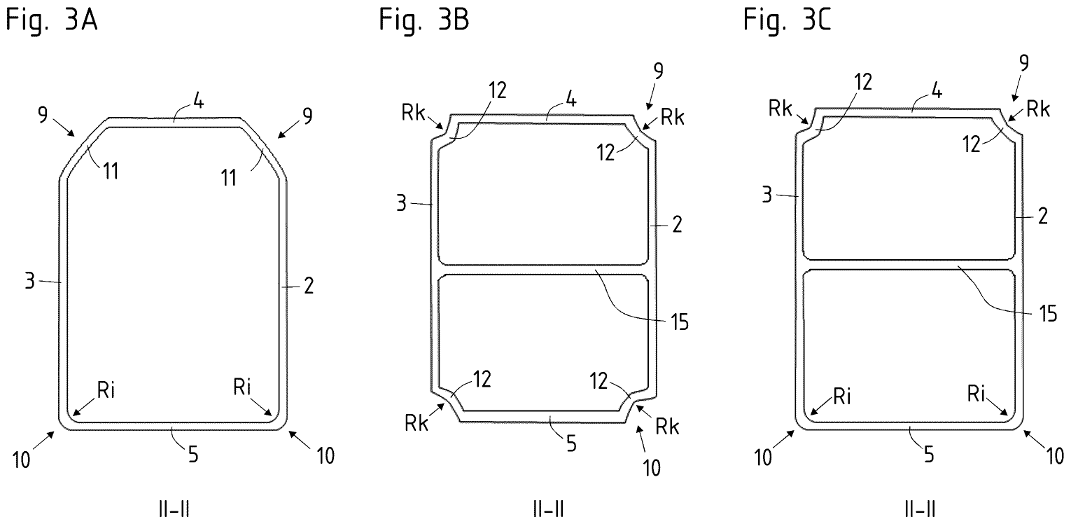

FIG. 3A to FIG. 3C show alternative embodiments of the deformation profile 1 in cross section according to section II-II of FIG. 2A, wherein they represent the initial profile or a length section without beads in the side walls.

According to FIG. 3A, only the upper corner areas 9 are designed as a chamfer 11 according to the disclosure. The lower corner areas 10 have a convex shape having a radius Ri. Due to the design according to the disclosure of the upper corner areas 9, in this embodiment only the upper wall 4 is suitable for coupling with an additional attachment part 8.

In FIG. 3B, the upper corner areas 9 and the lower corner areas 10 have a concave shape 12 according to the disclosure in cross section. The concave shape 12 also prevents the bulges 7 from protruding beyond the upper wall 4 or the lower wall 5. This is because when the beads 6 are formed into the side walls 2, 3, the corner area 9, 10 is pressed inwards or into the middle by the predetermined concave shape. At the same time, the inner wall is locally deformed upwards or downwards like a hump. The concave shape 12 has a radius Rk between 12 mm and 25 mm.

In the alternative embodiment according to FIG. 3C, only the upper corner areas 9 have a concave shape 12. The lower corner areas 10 have a convex shape having a radius Ri. While the upper corner areas 9 having the concave shape 12 have a radius Rk of 20 mm, the lower convexly shaped corner areas 10 have a radius Ri of 10 mm. Thus, the radius Ri of the lower corner areas 10 not designed according to the disclosure is 50% smaller than the radius Rk of the upper corner areas 9 according to the disclosure. In the length section (not shown) according to section III-III having beads, a flat connection surface only results in the upper wall.

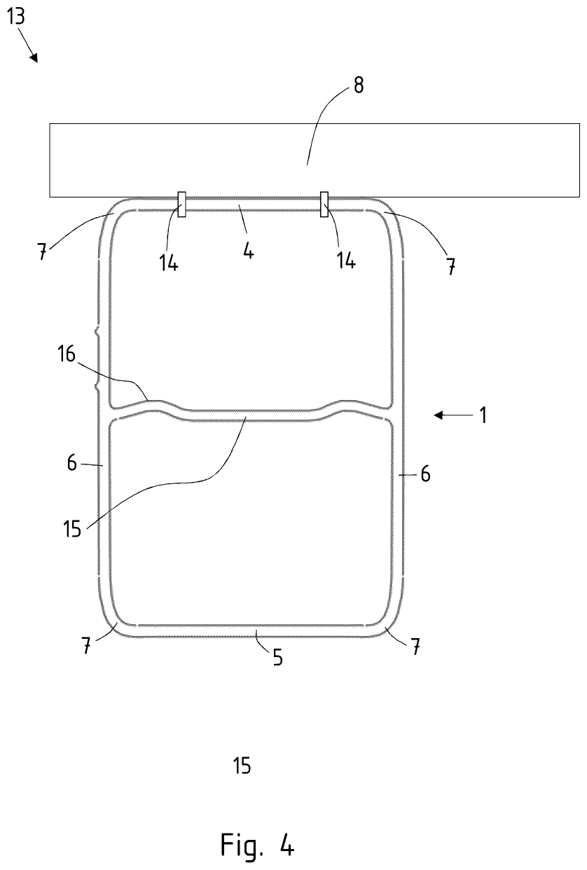

FIG. 4 shows a deformation profile arrangement 13 according to the disclosure, including a deformation profile 1 and an attachment 8. The attachment 8 is detachably coupled to the upper wall 4 of the deformation profile 1 by means of coupling means 14. Since the bulges 7 do not protrude beyond the upper wall 4, the attachment 8 is able to be arranged as close as possible and thus in a space-saving manner on the deformation profile 1 or on the upper wall 4.

In an alternative embodiment of the deformation profile arrangement 13, an additional attachment 8 is able to be detachably coupled to the lower wall 5.

The deformation profiles 1 according to the representations in FIG. 2, FIG. 3B, FIG. 3C, and FIG. 4 are designed as a multi-chamber profile. In the deformation profiles 1 shown, these are divided into two chambers by an inner wall 15. The inner wall 15 extends parallel to the upper wall 4 and to the lower wall 5 between the two side walls 2, 3. A deformation profile 1 is able to have more than one inner wall 15.

In a longitudinal section having a bead 6, the inner wall 15 has a hump 16 directed upwards in the direction of the upper wall 4. A hump is also able to be formed downwards towards the lower wall 5.

The disclosure also relates to a deformation profile arrangement in the form of a bumper arrangement for a motor vehicle. The bumper arrangement including a cross member and two deformation profiles, by which the cross member is connected to a vehicle, wherein the deformation profiles 1 are designed as a multi-chamber profile and have at least one inner wall 15, which extends parallel to the upper wall 4 and the lower wall 5, wherein the inner wall 15 has an upwardly or downwardly directed hump 16 in the longitudinal section having a bead 6.

The deformation profiles 1 are extruded. The side walls 2, 3, the upper wall 4, and the lower wall 5 as well as optional inner walls 15 are made in one piece using the same material as an extruded profile.

The upper wall 4 and/or the lower wall 5 of a deformation profile 1 has an outer overall surface, which includes a flat surface extending in a horizontal plane plane-parallel to the horizontal and the corner area surfaces extending inclined to the horizontal in the corner areas 9 and/or in the corner areas 10. The proportion of the flat surface to the overall surface is 30% to 65%.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-9. (canceled)

10. A deformation profile comprising:
two opposite side walls, wherein the two opposite side walls are connected by an upper wall and a lower wall and the two opposite side walls have at least one bead extending over an entire height of a respective side wall of the two opposite side walls,
an upper corner area is between the two opposite side walls and the upper wall, and
a lower corner area is between the two opposite side walls and the lower wall, wherein
the deformation profile is extruded and the upper corner area and the lower corner area comprise a concave shape or a chamfer in cross section.

11. The deformation profile according to claim 10, wherein the at least one bead comprises two beads opposite to one another in the two opposite side walls and in a same longitudinal section.

12. The deformation profile according to claim 10, wherein the deformation profile comprises a crash box.

13. The deformation profile according to claim 10, wherein the chamfer comprises a chamfer angle between 25° and 65°.

14. The deformation profile according to claim 10, wherein the upper wall and the lower wall comprise an outer surface which comprises a flat surface extending in a horizontal plane plane-parallel to a horizontal surface of the deformation profile, and the upper and lower corner surfaces extending inclined to the horizontal surface, and a proportion of a planar surface to the outer surface is 30% to 65%.

15. The deformation profile according to claim 10, wherein the chamfer has a length between 12 and 25 mm in cross section.

16. The deformation profile according to claim 10, wherein the concave shape has a radius between 12 and 25 mm.

17. A deformation profile arrangement comprising the deformation profile according to claim 10 and an attachment, wherein the attachment is detachably coupled to the upper wall or the lower wall.

18. A bumper arrangement comprising a cross beam and the deformation profile according to claim 10 comprising two deformation profiles, by which the cross beam is connected to a vehicle, wherein the two deformation profiles comprise a multi-chamber profile comprising at least one inner wall which extends parallel to the upper wall and the lower wall, and the inner wall has an upwardly or downwardly directed hump in the longitudinal section having a bead.

19. The deformation profile according to claim 10, wherein the deformation profile comprises a multi-chamber crash box.

20. The deformation profile according to claim 10, wherein the deformation profile comprises a longitudinal beam.

21. The deformation profile according to claim 10, wherein the chamfer comprises a chamfer angle between 35° and 55°.

22. The deformation profile according to claim 10, wherein the chamfer comprises a chamfer angle between 40 and 50°.
